(19) United States
(12) Patent Application Publication
(10) Pub. No.: US 2009/0088551 A1
(43) Pub. Date: Apr. 2, 2009

(54) POLYIMIDE FILM

(75) Inventors: SHINSUKE YAMASHITA, Aichi (JP); Hiroki Ishikawa, Aichi (JP)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. du Pont de Nemours and Company, Wilmington (DE)

(21) Appl. No.: 12/236,927

(22) Filed: Sep. 24, 2008

(30) Foreign Application Priority Data
Sep. 27, 2007 (JP) 2007-250600

(51) Int. Cl. C08G 73/10

(52) U.S. Cl. 528/353

(57) ABSTRACT

The objective of the present invention is to provide a polyimide film with decreased water absorption. A polyimide film, which is made of diamine and tetracarboxylic dianhydride, characterized in that tetracarboxylic dianhydride, which constitutes polyimide, contains tetracarboxylic dianhydride.

### CROSS-REFERENCE TO RELATED APPLICATION

This application claims priority to Japanese Patent Application 2007-250600 filed Sep. 27, 2007.

### FIELD OF INVENTION

The present invention relates to a polyimide film having a low water absorption coefficient.

### BACKGROUND OF THE INVENTION

A polyimide film, which is obtained by polycondensing tetracarboxylic dianhydride and diamine, has excellent heat resistance, insulation property and mechanical property. Therefore, conventionally, it is widely used as the base film for a flexible print substrate.

However, since the polyimide film has a high polarity, it easily absorbs water by its nature. When the polyimide film, which is used as the base film for a flexible print substrate, absorbs water, because of the dimension change, which is caused by water absorption, and the high dielectric constant of water, the substantial dielectric constant of the film is increased. As a result, problems such as decrease in the diffusion speed, increase in the transmission loss, decrease in the transmission density and signal delay are generated, which create obstacles for the high integration and high-speed actuation of electronic components such as semiconductors and mounting boards equipped with said components. Therefore, conventionally, studies to decrease the water absorption have been undertaken.

As a means to meet the above described demand, there is a method, which uses low water absorption fluorine-containing monomer (for example, see Patent Reference 1). However, fluorine-containing monomer is normally expensive compared with monomer that does not contain fluorine, and is not suitable for a common use.

Also, there is a study of a method wherein polymer with low water absorption is blended (for example, see Patent Reference 2). However, this method has a disadvantage that the heat resistance, which is one of the excellent properties of the polyimide film, is decreased.

### DESCRIPTION OF RELATED ART

[Patent Reference 1] Japanese unexamined published application No. 2000-143984.

[Patent Reference 2] Japanese unexamined published application No. Hei 11-129399.

### SUMMARY OF THE INVENTION

The present invention was created in order to solve the above described conventional problems. Therefore, the objective of the present invention is to provide a polyimide film with low water absorption.

To achieve the above described objective, the present invention provides a polyimide film, which is made of diamine and tetracarboxylic dianhydride, characterized in that tetracarboxylic dianhydride, which constitutes polyimide, contains tetracarboxylic dianhydride, which is expressed by Chemical Formula (1) below:

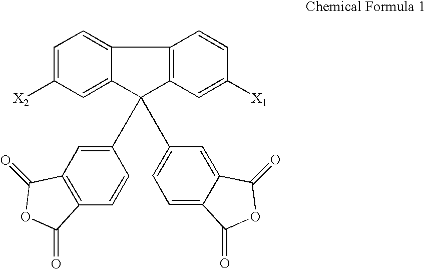

Here, X1 and X2 represent groups, which are selected from hydrogen atoms, alkyl groups, halogen atoms, hydroxyl groups, carboxyl groups and alkoxyl groups. X1 and X2 may be the same or different.

Here, in the polyimide film of the present invention, tetracarboxyl dianhydride, which is expressed by Chemical Formula (1), accounts for 5 mol % or more of the carboxylic acid element, which constitutes polyimide and the water absorption coefficient is 2.0% or lower.

### EFFECTS OF THE INVENTION

According to the present invention, which will be described below, it is possible to obtain a polyimide film with low water absorption. In other words, the polyimide film of the present invention has low water absorption and when it is used as the base film for a flexible print substrate, it can prevent the dimension change, which is caused by water absorption, and substantially decreases the dielectric constant.

### MOST PREFERRED EXAMPLE OF THE INVENTION

Next, the polyimide film of the present invention will be described in detail.

First, polyamic acid, which is the precursor of the polyamide film of the present invention, will be described. The polyamic acid, which is used in the present invention, is obtained by polymerizing diamine and tetracarboxylic dianhydride.

As the method for forming the polyimide film of the present invention, it is possible to use a variety of known methods such as the one in which polyamic acid is polymerized and then imidized. For example, as the method for manufacturing polyamic acid, it is possible to use a variety of known methods. Normally, polyamic acid is manufactured by dissolving a virtually equimolar amount of acid dianhydride and diamine into an organic solvent and stirring the obtained polyamic acid organic solvent solution at controlled temperature until said polymerization of acid dianhydride and diamine is completed. The concentration of the obtained polyamic acid solution is normally 5 to 35 wt. %, or preferably, 10 to 30 wt. %. When the concentration of the polyamic acid solution is in the above described range, it is possible to obtain a suitable molecular weight and solution viscosity.

As the polymerization method, it is possible to use a variety of known methods. The following polymerization methods are especially preferable.

In other words, examples of the polymerization method include: a method wherein diamine is dissolved into a virtually equimolar amount of organic polar solvent and polymerization is done by reacting the resultant solvent with an equimolar amount of tetracarboxylic dianhydride; a method wherein tetracarboxylic dianhydride and an excessively small molar amount of diamine compound relative to the molar amount of said tetracarboxylic dianhydride are reacted in an organic polar solvent so as to obtain a pre-polymer, which has acid anhydride groups in both of its terminuses, and then polymerization is done by using a diamine compound throughout the entire process so that the molar amount of tetracarboxylic dianhydride and that of the diamine compound are virtually equivalent; a method wherein tetracarboxylic dianhydride and an excessively large molar amount of diamine compound relative to the molar amount of said tetracarboxylic dianhydride are reacted in an organic polar solvent so as to obtain a pre-polymer, which has acid anhydride groups in both of its terminuses, and, after the diamine compound is added to the pre-polymer, polymerization is done by using a diamine compound throughout the entire process so that the molar amount of tetracarboxylic dianhydride and that of the diamine compound are virtually equivalent; a method wherein, after tetracarboxylic dianhydride is dissolved and/or dispersed in an organic polar solvent, polymerization is done by using a diamine compound so that the molar amount of tetracarboxylic dianhydride and that of the diamine compound are virtually equivalent; and a method wherein polymerization is done by reacting a mixture of virtually equimolar amount of tetracarboxylic dianhydride and diamine in an organic polar solvent.

According to the present invention, it is possible to use polyamic acid, which is obtained by using any one of the above described polymerization methods and the polymerization method is not limited to a specific one. Among the above described polymerization methods, considering the stable control of the process, it is preferable to use the polymerization method wherein, after all the diamine elements used in the entire process are dissolved into the organic solvent, the tetracarboxylic dianhydride element is added so that the molar amount of the tetracarboxylic dianhydride and that of the diamine element are virtually equivalent.

According to the present invention, it is an indispensable condition that the tetracarboxylic dianhydride element, which will be described below, must be contained.

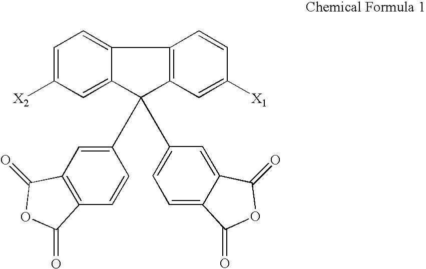

Here, X1 and X2 represent groups, which are selected from hydrogen atoms, alkyl groups, halogen atoms, hydroxyl groups, carboxyl groups and alkoxyl groups. X1 and X2 may be the same or different.

The amount of tetracarboxylic dianhydride is preferably 5 mol % or more of the carboxylic acid element, which constitutes polyimide. More preferably, the amount of tetracarboxylic dianhydride is 10 mol % or more, or even more preferably, 15 mol % or more. If the amount of tetracarboxylic dianhydride is in these ranges, the low water absorption, which is the objective of the present invention, is more achievable. If the amount of tetracarboxylic dianhydride is less than 5 mol %, this effect of achieving the low water absorption may not be obtained, which is not desirable. Also, there is no upper limit to the amount of tetracarboxylic dianhydride. Depending on the intended usage, the amount of tetracarboxylic dianhydride can be determined.

Examples of the tetracarboxylic dianhydride element, which can be used in the present invention include: pyromellitic acid dianhydride, 2,3,6,7-naphthalenetetracarboxylic dianhydride, 3,3′,4,4′-diphenyltetracarboxylic dianhydride, 2,2′-bis(3,4-dicarboxyphenyl)propane dianhydride, bis(3,4-dicarboxyphenyl)sulfone acid dianhydride, 3,4,9,10-perylenetetracarboxylic dianhydride, bis(3,4-carboxyphenyl)ether dianhydride, naphthalene-1,2,4,5-tetracarboxylic dianhydride, naphthalene-1,4,5,8-tetracarboxylic dianhydride, decahydro-naphthalene-1,4,5,8-tetracarboxylic dianhydride, 4,8-dimethyl-1,2,3,5,7-hexahydronaphthalene-1,2,5,6-tetracarboxylic dianhydride, 2,6-dichloronaphthalene-1,4,5,8-tetracarboxylic dianhydride, 2,7-dichloronaphthalene-1,4,5,8-tetracarboxylic dianhydride, 2,3,6,7-tetrachloronaphthalene-1,4,5,8-tetracarboxylic dianhydride, phenanthrene-1,8,9,10-tetracarboxylic dianhydride, 2,2,bis(2,3-dicarboxylphenyl)ethane dianhydride, 1,1-bis(3,4-dicarboxyphenyl)ethane dianhydride, bis(2,3-dicarboxyphenyl)methane dianhydride, bis(3,4-dicarboxyphenyl)methane dianhydride, bis(3,4-dicarboxyphenyl)sulfone dianhydride, benzene-1,2,3,4-tetracarboxylic dianhydride and 3,4,3′,4′-benzophenonetetracarboxylic dianhydride, or a mixture of two or more types thereof.

On the other hand, examples of the diamine element, which can be used in the present invention, include: 4,4′-diaminodiphenylether, 3,4′-diaminodiphenylether, methaphenylenediamine, 4,4′-diaminodiphenylpropane, 4,4′-diaminodiphenylmethane, benzidine, 4,4′-diaminodiphenylsufide, 4,4′-diaminodiphenylsulfone, 3,3′-diaminodiphenylsulfone, 2,6-diaminopyridine, bis-(4-aminophenyl)diethylsilane, bis-(4-aminophenyl)diphenylsilane, 3,3;-dichlorobenzidine, bis-(4-aminophenyl)ethylphosphineoxide, bis-(4-aminophenyl)phenylphosphineoxide, bis-(4-aminophenyl)-N-phenylamine, bis-(4-aminophenyl)-N-methylamine, 1,5-diaminonaphthalene, 3,3′-dimethyl-4,4′-diaminobiphenyl, 3,4′-dimethyl-3′,4-diaminobiphenyl, 3,3′-dimethoxybenzidine, 2,4-bis(β-amino-t-butyl)toluene, bis(p-β-amino-t-butyl-phenyl)ether, p-bis-(2-methyl-4-amino-bentyl)benzene, p-bis-(1,1-dimethyl-5-amino-bentyl)benzene, m-xylylenediamine, p-xylylenediamine, 1,3-diaminoadamantane, 3,37-diamino-1,17-diadamantane, 3,3′-diamino-1,1′-diadamantane, bis(p-amino-cyclohexyl)methane, hexamethylenediamine, peptamethylenediamine, octamethylenediamine, nonamethylenediamine, decamethylenediamine, 3-methylheptamethylenediamine, 4,4-dimethylheptamethylenediamine, 2,11diamino-dodecane, 1,2-bis-(3-amino-propoxy)ethane, 2,2-dimethylpropylenediamine, 3-methoxy-hexamethylenediamine, 2,5-dimethylhexamethylenediamine, 3-methoxy-hexamethylenediamine, 2,5-dimethylhexamethylenediamine, 5-methylnonamethylenediamine, 5-methylnonamethylenediamine, 1,4-diamino-cyclohexane, 1,12-diamino-octadecane, 2,5-diamino-1,3,4-oxadiazol, 2,2-bis(4-aminophenyl)hexafluoropropane, N-(3-aminophenyl)-4-aminobenzamide and 4-aminophenyl-3-aminobenzoate.

Next, examples of the organic solvent, which can be used in the present invention, include: N,N-dimethylformamide, N,N-dimethylacetoamide, N,N-diethylformamide, N,N-diethylacetoamide, N-dimethylmethoxyacetoamide, N-methyl-caprolactam, dimethylsulfoxide, N-methyl-2-pyrolidone, tetramethyl urea, pyridine, dimethylsulfone, hexamethylphosphoramide, tetramethylenesulfone, formamide, N-methylformamide and butyrolactone. The above described organic solvents may be used singly, in combination or together with a solvent with low solubility such as benzene, benzonitrile, butyrolactone, xylene and cyclohexane.

According to the present invention, it is possible to imidize without adding a catalyst. However, in some cases, it is desirable to add the catalyst and dehydrating agent, which will be described below.

As the catalyst, it is preferable to use tertiary amine groups. Examples of the tertiary amine groups include: trimethylamine, triethylamine, triethylenediamine, pyridine, isoxylene, 2-ethylpyridine, 2-methyl pyridine, N-ethyl morpholine, N-methyl morpholine, diethylcyclohexylamine, N-dimethycyclohexylamine, 4-benzoylpyridine, 2,4-lutidine, 2,6-lutidine, 2,4,6-collidine, 3,4-lutidine, 3,5-lutidine, 4-methylpyridine, 3-methylpyridine, 4-isopropylpyridine, N-dimethylbenzylamine, 4-benzypyridine and N-dimethyldodecylamine.

Also, examples of the dehydrating agent include: organic carboxylic anhydride, N,N-dialkylcarbodiimido group, lower fatty acid halide, halogenated lower fatty acid halide, halogenated lower fatty acid anhydride, arylphosphonic acid dihalide and thionyl halide. Here, examples of organic carboxylic anhydride include: acetic anhydride, propionic anhydride, butyric anhydride, valeric anhydride, a mixed anhydride of the above described anhydrides, a mixed anhydride of monocarboxylic acid such as benzoic acid and naphthoic acid and a mixed anhydride of carbonic acid, formic acid and fatty acid ketene group (ketene and dimethylketene). Among them, it is preferable to use acetic anhydride and ketene groups.

Also, examples of the acid anhydride, which can be used in the present invention, include: acid anhydride of o-, m- or p-toluic acid, m- or p-ethylbenzoic acid, p-propylbenzoic acid, p-isopropylbenzoic acid, anisic acid, o-, m- or p-nitrobenzoic acid, o-, m- or p-halobenzoic acid, a variety of dibromobenzoic acid or dichlorobenzoic acid, tribromobenzoic acid or trichlorobenzoic acid, isomeric forms of dimethylbenzoic acid such as hemethylic acid, 3,4-xylylic acid, isoxylic acid, mesitylic acid, veratric acid, trimethoxybenzoic acid, α- or β-naphthoic acid or biphenylcarboxylic acid; a mixed anhydride of the above described anhydrides; a mixed anhydride of fatty acid monocarboxylic acid such as acetic acid and propionic acid; and a mixed anhydride of carbonic acid or formic acid.

N,N′-dialkylcarbodiimide group is expressed by a formula: R—N═C═N—R (in this formula, R may represent different alkyl groups, but normally, it represents the same) and preferably, the R groups represent lower alkyl groups with a number of carbons of 1 to 8.

Examples of the dehydrating agent containing halogen include: acetyl chloride, acetyl bromide, acetyl iodide, acetyl fluoride, propionyl chloride, propionyl bromide, propionyl iodide, propionyl fluoride, isobutyryl chloride, isobutyryl bromide, n-butyryl chloride, n-butyryl bromide, valeryl chloride, monochloroacetyl chloride, dichloroacetyl chloride, trichloroacetyl chloride, bromoacetyl bromide, chloroacetic anhydride, phenylphosphonic dichloride, thionyl chloride, thionyl bromide, thionyl fluoride, thionyl chlorofluoride and trifluoroacetic anhydride. Although the method for forming the polyimide film of the present invention is not limited to a specific one, it is normally formed by flow casting or extruding polyamic acid solution in a film form, drying and heat-treating the resultant film thereby accelerating the imidization.

For example, by casting polyamic acid solution, in which a cyclized catalyst and dehydrating agent are contained, on a support and molding it in a film form and a part of the imidization is done on the support so as to produce a gel film with a self bearing property. Then, the film is peeled off from the support, heat-dried, imidized and heat-treated.

The above described support means the support made from glass, metal and high-molecular-weight film. It has a plane surface and can support polyamic acid, which is cast on the support. The support can be a metal rotating drum or endless belt. The temperature of the support is controlled by the heat media of liquid or gaseous body and/or the radiation heat of an electronic heater.

The cast polyamic acid solution is heated at 30 to 200° C., or preferably, 40 to 150° C. by the receiving heat from the support and/or that of a heat source such as a hot air and electronic heater and makes a ring-closing reaction. By drying the volatile matter content such as the liberated organic solvent, the polyamic solution becomes a gel film, which has a self bearing property and peeled off from the support.

The gel film, which is peeled off from the support, is fixed at its ends and heat-treated so as to become a polyimide film. Here, the film may be stretched.

After that, the polyimide film is gradually cooled in a gradual cooling machine. Then, the polyimide film is rolled up in a core thereby obtaining a film roll. It is preferable to roll up the polyimide film in a serpentine form so as to decrease unevenness in the thickness of the roll and prevent so called gauge band. Also, in rolling up the polyimide film, it is preferable to cut out the ends of the film so that the end faces are even.

The polyimide film of the present invention has a film thickness of 3 to 250 μm, or preferably, 7 to 100 μm. In other words, if the film thickness if less than 3 μm, it is difficult to keep the shape. On the other hand, if the film thickness is more than 250 μm, the flexibility is decreased, which is not suitable for a flexible circuit substrate.

The water absorption of the polyimide film of the present invention is preferably 2.0% or lower, or more preferably, 1.8% or lower, or even more preferably, 1.7% or lower. If the water absorption is 2.0% or higher, the degree of the change in dimensions at the time of water absorption and dehydration is increased, which is not desirable. Although there is no lower limit to the water absorption, around 0.2% is the rough standard as a polyimide film.

The linear thermal expansion coefficient of the polyimide film of the present invention at 50 to 200° C. is preferably 30×10⁶/K or lower, or more preferably, 27×10⁶/K or lower, or even more preferably, 25×10⁶/K or lower.

### EXAMPLES

Next, the present invention will be described more practically by using working examples.

Each property of the polyimide films of the working examples were evaluated by using the following methods:

### Water Absorption

After the film was immersed in distilled water for 48 hours, it was extracted from the water. Water on the surface of the film was quickly wiped off and a sample was cut out into a size of about 5 mm×15 mm. After the film was put in a slow electricity device, it was evaluated by a thermogravimetric analyzer TG-50, which was made by Shimadzu Co., Ltd. The rate of temperature increase was 10° C./min. and the temperature was increased to 200° C. Based on the change in weight, the water absorption was calculated by using the following formula:

Water absorption (%)={(weight before the heating process)−(weight after the heating process)}/(weight after the heating process)×100

### Linear Thermal Expansion Coefficient)

By using TMA-50, which was made by Shimadzu Co., Ltd, the linear thermal expansion coefficient was measured at measurement temperature of 50 to 200° C. and at the rate of temperature increase of 10° C./min.

### Working Example 1

20.0 g of 4,4′-diaminodiphenylether and 176.7 g of N,N′-dimethylacetoamide were fed to a separable flask with a capacity of 300 ml having a DC stirrer and the mixture was stirred at room temperature in a nitrogen atmosphere. The mixture was stirred for 30 minutes and then 4.6 g (10 mol %) of 9,9-bis(3,4-dicarboxyphenyl)fluorenic dianhydride and 19.6 g of pyromellitic dianhydride were fed to the flask in several batches and the mixture was stirred for 1 hour thereby obtaining polyamic acid solution.

12 g of β-picoline and 14 g of acetic anhydride were added to 100 g of the cooled polyamic solution. The solution was flow cast in a form of a glass plate by using an applicator thereby obtaining a gel film with a self bearing property. The obtained gel film was heat-treated at 200° C. for 30 minutes, at 300° C. for 20 minutes and at 400° C. for 5 minutes thereby obtaining a polyimide film with a film thickness of 25 μm. The water absorption of the obtained polyimide film was 1.6% and the linear thermal expansion coefficient was 26×10⁶/K.

### Working Example 2

20.0 g of 4, 4′-diaminodiphenylether and 171.9 g of N,N′-dimethylacetoamide were fed to a separable flask with a capacity of 300 ml having a DC stirrer and the mixture was stirred at room temperature in a nitrogen atmosphere. The mixture was stirred for 30 minutes and then 2.3 g (5 mol %) of 9,9-bis(3,4-dicarboxyphenyl)fluorenic dianhydride and 20.7 g of pyromellitic dianhydride were fed to the flask in several batches and the mixture was stirred for 1 hour thereby obtaining polyamic acid solution.

12 g of β-picoline and 14 g of acetic anhydride were added to 100 g of the cooled polyamic solution. The solution was flow cast in a form of a glass plate by using an applicator thereby obtaining a gel film with a self bearing property. The obtained gel film was heat-treated at 200° C. for 30 minutes, at 300° C. for 20 minutes and at 400° C. for 5 minutes thereby obtaining a polyimide film with a film thickness of 25 μm. The water absorption of the obtained polyimide film was 1.7% and the linear thermal expansion coefficient was 25×10⁶/K.

### Working Example 3

164.7 g of N,N′-dimethylacetoamide was fed to a separable flask with a capacity of 300 ml having a DC stirrer and 1.6 g of paraphenylenediamine and 3.2 g of pyromellitic dianhydride were fed to the flask and reacted at normal temperature and pressure for 1 hour. Then, 17.1 g of 4,4′-diaminodiphenylether was fed to the flask and the mixture was stirred until it was homogeneous. After that, 5.9 g of 3,3′,4,4′-biphenyltetracarboxylic dianhydride was added to the flask and reacted for 1 hour. Subsequently, 13.2 g of pyromellitic dianhydride and 2.3 g (5 mol %) of 9,9-bis(3,4-dicarboxyphenyl)fluorenic dianhydride were added to the flask and further reacted for 1 hour thereby obtaining polyamic acid solution.

12 g of β-picoline and 14 g of acetic anhydride were added to 100 g of the cooled polyamic solution. The solution was flow cast in a form of a glass plate by using an applicator thereby obtaining a gel film with a self bearing property. The obtained gel film was heat-treated at 200° C. for 30 minutes, at 300° C. for 20 minutes and at 400° C. for 5 minutes thereby obtaining a polyimide film with a film thickness of 25 μm. The water absorption of the obtained polyimide film was 1.7% and the linear thermal expansion coefficient was 16×10⁶/K.

### Comparative Example 1

20.0 g of 4,4′-diaminodiphenylether and 176.7 g of N,N′-dimethylacetoamide were fed to a separable flask with a capacity of 300 ml having a DC stirrer and the mixture was stirred at room temperature in a nitrogen atmosphere. The mixture was stirred for 30 minutes and then 21.8 g of pyromellitic dianhydride was fed to the flask in several batches and the mixture was stirred for 1 hour thereby obtaining polyamic acid solution.

12 g of β-picoline and 14 g of acetic anhydride were added to 100 g of the cooled polyamic solution. The solution was flow cast in a form of a glass plate by using an applicator thereby obtaining a gel film with a self bearing property. The obtained gel film was heat-treated at 200° C. for 30 minutes, at 300° C. for 20 minutes and at 400° C. for 5 minutes thereby obtaining a polyimide film with a film thickness of 25 μm. The water absorption of the obtained polyimide film was 2.3% and the linear thermal expansion coefficient was 27×10⁶/K.

### Comparative Example 2

164.7 g of N,N′-dimethylacetoamide was fed to a separable flask with a capacity of 300 ml having a DC stirrer and 1.6 g of paraphenylenediamine and 3.2 g of pyromellitic dianhydride were fed to the flask and reacted at normal temperature and pressure for 1 hour. Then, 17.1 g of 4,4′-diaminodiphenylether was fed to the flask and the mixture was stirred until it was homogeneous. After that, 5.9 g of 3, 3′,4,4′-biphenyltetracarboxylic dianhydride was added to the flask and reacted for 1 hour. Subsequently, 14.2 g of pyromellitic dianhydride was added to the flask and further reacted for 1 hour thereby obtaining polyamic acid solution.

12 g of β-picoline and 14 g of acetic anhydride were added to 100 g of the cooled polyamic solution. The solution was flow cast in a form of a glass plate by using an applicator thereby obtaining a gel film with a self bearing property. The obtained gel film was heat-treated at 200° C. for 30 minutes, at 300° C. for 20 minutes and at 400° C. for 5 minutes thereby obtaining a polyimide film with a film thickness of 25 μm. The water absorption of the obtained polyimide film was 2.1% and the linear thermal expansion coefficient was 16×10⁶/K. The results are shown in Table 1.

TABLE 1

| | | | | Com- | |
|---|---|---|---|---|---|
| | Working | Working | Working | parative | Comparative |
| | Example 1 | Example 2 | Example 3 | Example 1 | Example 2 |
| Amount of | 10 | 5 | 5 | — | — |
| fluorenic | | | | | |
| anhydride | | | | | |
| (mol %) | | | | | |
| Other | ODA, | ODA, | ODA, | ODA, | ODA, |
| monomer | PMDA | PMDA | PMDA, | PMDA | PMDA, |
| used | | | PDA, | | PDA, BPDA |
| | | | BPDA | | |
| Water | 1.6 | 1.7 | 1.7 | 2.3 | 2.1 |
| absorption | | | | | |
| (%) | | | | | |
| Thermal | 26 | 25 | 16 | 27 | 16 |
| expansion | | | | | |
| coefficient | | | | | |
| (10⁶/K) | | | | | |

ODA: 4,4′-diaminodiphenylether;
PMDA: pyromellic dianhydride;
PDA: paraphenylenediamine;
BPDA: biphenyltetracarboxylic dianhydride

Based on the results of Table 1, it is found that, when the film contains fluorenic anhydride groups, the water absorption of the film is decreased.

### Potential Industrial Use

Since the polyimide film of the present invention has low water absorption, it can prevent changes in dimensions of the film and decrease the substantial dielectric constant. Therefore, it is possible to favorably use the polyimide film of the present invention as the base film for a flexible print substrate.

What is claimed is:

1. A polyimide film, which is made of diamine and tetracarboxylic dianhydride, characterized in that tetracarboxylic dianhydride, which constitutes polyimide, contains tetracarboxylic dianhydride, which is expressed by Chemical Formula (1) below: 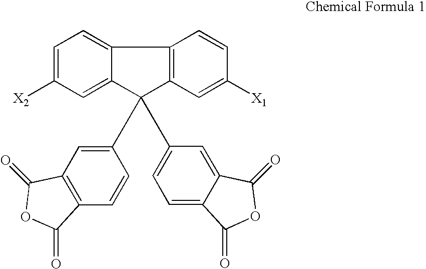
Here, X1 and X2 represent groups, which are selected from hydrogen atoms, alkyl groups, halogen atoms, hydroxyl groups, carboxyl groups and alkoxyl groups. X1 and X2 may be the same or different.

2. The polyimide film as set forth in claim 1, characterized in that tetracarboxyl dianhydride, which is expressed by Chemical Formula (1), accounts for 5 mol % or more of the carboxylic acid element, which constitutes polyimide.

3. The polyimide film as set forth in claim 1 or 2, characterized in that the water absorption coefficient is 2.0% or lower.
